(19) United States
(12) Patent Application Publication
(10) Pub. No.: US 2026/0214550 A1
(43) Pub. Date: Jul. 23, 2026

(54) NETWORK SLICE AVAILABILITY FOR LEGACY DEVICES IN A WIRELESS COMMUNICATION NETWORK

(71) Applicant: Lenovo (Singapore) Pte. Limited, Singapore (SG)

(72) Inventors: Genadi Velev, Darmstadt (DE); Dimitrios Karampatsis, Ruislip (GB)

(73) Assignee: Lenovo (Singapore) Pte. Limited, Singapore (SG)

(21) Appl. No.: 19/140,935

(22) PCT Filed: Feb. 24, 2023
(86) PCT No.: PCT/EP2023/054693

§ 371 Date: Jun. 18, 2025

(30) Foreign Application Priority Data
Dec. 22, 2022 (GR) 20220101073

(51) Int. Cl. H04W 48/08

(52) U.S. Cl. CPC H04W 48/08

(57) ABSTRACT

There is provided a method for a Policy Control Function (PCF), the method comprising: receiving availability information for a network slice associated with a user equipment (UE); determining at least one UE Route Selection Policy (URSP) rule for the UE, the at least one URSP rule considering the availability information of the network slice; and transmitting the at least one URSP rule to the UE.

### FIELD

The subject matter disclosed herein relates generally to the field of implementing network slice availability for legacy devices in a wireless communication network. This document defines a Policy Control Function (PCF) for a wireless communication network, a method for a PCF, an Access and Mobility Management Function (AMF) for a wireless communication network, a method for an AMF, a Unified Data Repository (UDR) for a wireless communication network, and a method in a UDR.

### INTRODUCTION

An important feature of the 5th generation (5G) of network systems (also abbreviated as 5GS) is considered to be the Network Slicing. The concept of Network Slicing enables a network operator to divide (“slice”) the network in finer granularity than that of the complete network. The finer granularity divisions of the network are called network slices. Such network slices tend to provide customized network connectivity (or network features) towards customers or application service providers.

A network slice is a logical network that comprises a set of network functions and corresponding resources (e.g. computing, storage, networking) necessary to provide certain network capabilities and network characteristics. A network slice can include the Core Network (5G core network, 5GC), control plane. and user plane Network Functions (NFs) and Access Network (e.g. 5G radio access network or fixed access network).

The UE can be configured with network slice relevant information, which is referred as Network Slice Selection Assistance information (NSSAI). The NSSAI may consist of single or multiple S-NSSAIs (single Network Slice Selection Assistance information). The UE requests registration to network slices by sending to the 5GC (e.g. the Access and Mobility management Function (AMF)) a Non-Access-Stratum (NAS) registration request message including a Requested NSSAI containing a list of one or more S-NSSAIs to which the UE wants to register.

Usually, the network slices are deployed homogeneously in a tracking area (TA). If a new network slice is deployed, the network operator can reconfigure the TAs in such a way the network slice remains uniformly supported in the cells within the TA. But if an operator does not want to change the TA borders, some network slices may not be uniformly supported in the TA and only some cells of the TA may support the network slice. Indeed, a desired requirement is that the 5GS should be able to support network slices serving only a subset of the cells of a tracking area. In other words, the network slice Area of Service (AoS) is not aligned with the configured tracking areas.

### SUMMARY

A problem in existing wireless communication networks is that the network slice AoS may be configured in the UE by sending the availability information of the network slice to the UE. However, only some new UEs will support such functionality. Legacy UEs, that is existing UEs developed before the completion of 3GPP Rel-18, may not support the availability information of the network slice. Further, some new UEs may have limited network slice capability and thus not support such functionality. Accordingly, there is a need to accommodate UEs that do not support availability information of a network slice.

Disclosed herein are procedures for indicating network slice availability for legacy devices in a wireless communication network. Said procedures may be implemented by a Policy Control Function (PCF) for a wireless communication network, a method for a PCF, an Access and Mobility Management Function (AMF) for a wireless communication network, a method for an AMF, a Unified Data Repository (UDR) for a wireless communication network, and a method in a UDR. While some examples are given in the context of Legacy UEs, it should be noted that the arrangements described herein are equally applicable to non-legacy UEs that do not support availability information of a network slice.

There is provided herein a Policy Control Function (PCF) for a wireless communication network, the PCF comprising: a processor; and a memory coupled with the processor. The processor is configured to cause the apparatus to: receive availability information for a network slice associated with a user equipment (UE); determine at least one UE Route Selection Policy (URSP) rule for the UE, the at least one URSP rule considering the availability information of the network slice; and transmit the at least one URSP rule to the UE.

There is further provided a method for a Policy Control Function (PCF), the method comprising: receiving availability information for a network slice associated with a user equipment (UE); determining at least one UE Route Selection Policy (URSP) rule for the UE, the at least one URSP rule considering the availability information of the network slice; and transmitting the at least one URSP rule to the UE.

There is further provided an Access and Mobility Management Function (AMF) for a wireless communication network, the AMF comprising a processor and a memory coupled with the processor. The processor is configured to cause the apparatus to: receive, for a User Equipment (UE), capability information associated with support of network slice availability policy by the UE; receive availability information for a network slice associated with the UE; and determine, based on the received capability information and the availability information, to send to a Policy Control Function (PCF) an indication about the availability information for the network slice.

There is further provided a method for an Access and Mobility Management Function (AMF), the method comprising: receiving, for a User Equipment (UE), capability information associated with support of network slice availability policy by the UE; receiving availability information for a network slice associated with the UE; and determining, based on the received capability information and the availability information, to send to a Policy Control Function (PCF) an indication about the availability information for the network slice.

There is further provided a Unified Data Repository (UDR) for a wireless communication network, the UDR comprising a processor; and a memory coupled with the processor. The processor is configured to cause the UDR to: receive network slice availability information for a network slice associated with a UE; receive from a Policy Control Function (PCF) a query to retrieve subscription data and policy data for the UE; and send to the PCF the requested subscription data and policy data for the UE and an indication about the availability information for the network slice for the UE.

There is further provided a method for a Unified Data Repository (UDR), the method comprising: receiving network slice availability information for a network slice associated with a UE; receiving from a Policy Control Function (PCF) a query to retrieve subscription data and policy data for the UE; and sending to the PCF the requested subscription data and policy data for the UE and an indication about the availability information for the network slice for the UE.

Such an arrangement allows a wireless communication network to configure network slice Area of Service in a legacy UE; where a legacy UE is one that was developed before the completion of 3GPP Rel-18, and which does not support the availability information of the network slice defined therein.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for indicating network slice availability for legacy devices in a wireless communication network will now be described, by way of example only, with reference to the accompanying drawings, in which:

FIG. 1 depicts an embodiment of a wireless communication system for indicating network slice availability for legacy devices in a wireless communication network;

FIG. 2 depicts a user equipment apparatus that may be used for implementing the methods described herein;

FIG. 3 depicts further details of a network node that may be used for implementing the methods described herein;

FIG. 4 shows one example of network slice deployment in a radio access network;

FIG. 5 shows a reference architecture of policy and charging control framework for the a 5G System;

FIG. 6 shows a signalling flow of how an AMF provides slice availability information to a PCF;

FIG. 7 illustrates a signalling flow showing how a UDR provides slice availability information to the PCF;

FIG. 8 illustrates a method for a Policy Control Function;

FIG. 9 illustrates a method for an Access and Mobility Management Function;

FIG. 10 illustrates a method for a Unified Data Repository (UDR);

FIG. 11 illustrates a method performed by an AMF; and

FIG. 12 illustrates a method performed by an SMF.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

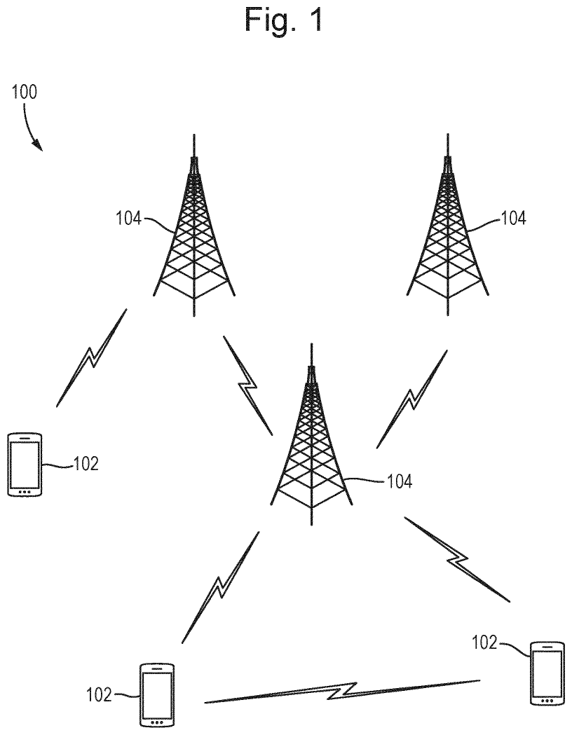

FIG. 1 depicts an embodiment of a wireless communication system 100 for indicating network slice availability for legacy devices in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may be embodied as a user equipment apparatus 200, and/or a UE 620, 720 as described herein. The base unit 104 may be embodied as a network unit 300, a PCF 530, 630, 730, an AMF 514, 614, 714 and/or a UDR 506, 606, 706 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

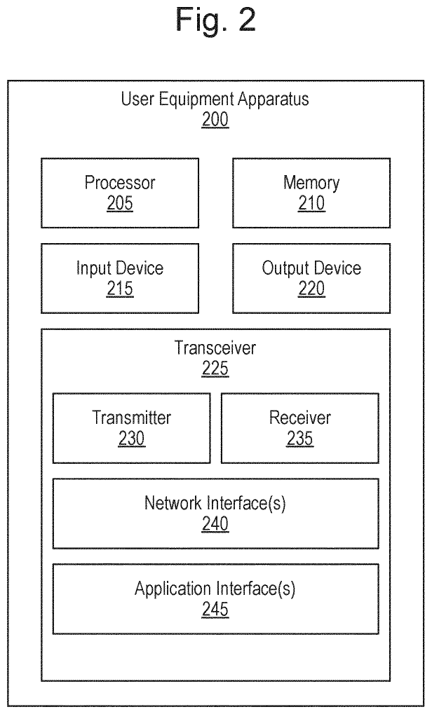

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be embodied as a remote unit 102, and/or a UE 620, 720 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

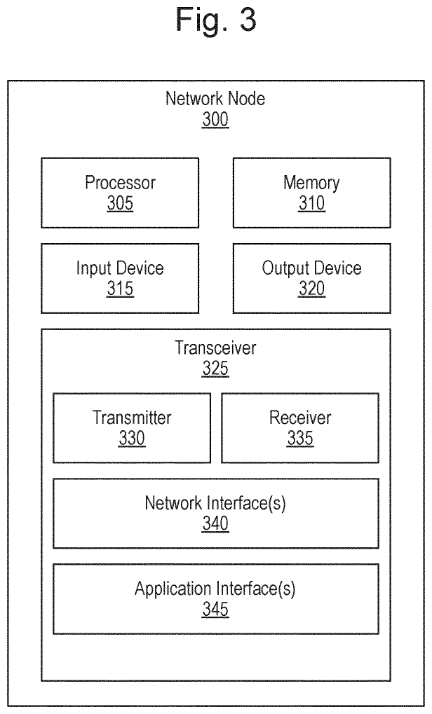

FIG. 3 depicts further details of the network node 300 that may be used for implementing the methods described herein. The network node 300 may be one implementation of an entity in the wireless communication network, e.g. in one or more of the wireless communication networks described herein. The network node 300 may be embodied as a base unit 104, a PCF 530, 630, 730, an AMF 514, 614, 714 and/or a UDR 506, 606, 706 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

An important feature of the 5th generation (5G) of network systems (also abbreviated as 5GS) is considered to be the Network Slicing. The concept of Network Slicing enables a network operator to divide (“slice”) the network in finer granularity than that of the complete network. The finer granularity divisions of the network are called network slices. Such network slices tend to provide customized network connectivity (or network features) towards customers or application service providers.

A network slice is a logical network that comprises a set of network functions and corresponding resources (e.g. computing, storage, networking) necessary to provide certain network capabilities and network characteristics. A network slice can include the Core Network (5G core network, 5GC), control plane. and user plane Network Functions (NFs) and Access Network (e.g. 5G radio access network or fixed access network).

The UE can be configured with network slice relevant information, which is referred as Network Slice Selection Assistance information (NSSAI). The NSSAI may consist of single or multiple S-NSSAIs (single Network Slice Selection Assistance information). The UE requests registration to network slices by sending to the 5GC (e.g. the Access and Mobility management Function (AMF)) a Non-Access-Stratum (NAS) registration request message including a Requested NSSAI containing a list of one or more S-NSSAIs to which the UE wants to register. The 5GC (e.g. AMF) may send to the UE in the registration accept message or in UE configuration update command message one or more of the following elements related to the network slice configuration of the UE: allowed NSSAI, configured NSSAI, rejected NSSAI or pending NSSAI. The NSSAI is a list of one or more S-NSSAIs.

More information about the network slices and 5GS can be found in 3GPP TS 23.501, V17.6.0, 2022-09, “System Architecture for the 5G System”, and 3GPP TS 23.502, V17.6.0, 2022-09, “Procedures for the 5G System”, incorporated herein by reference.

Usually, the network slices are deployed homogeneously in a tracking area (TA). If a new network slice is deployed, the network operator can reconfigure the TAs in such a way the network slice remains uniformly supported in the cells within the TA. But if an operator does not want to change the TA borders, some network slices may not be uniformly supported in the TA and only some cells of the TA may support the network slice. Indeed, a desired requirement is that the 5GS should be able to support network slices serving only a subset of the cells of a tracking area. In other words, the network slice Area of Service (AoS) is not aligned with the configured tracking areas.

In such case, the network operator may configure the cells of a TA that are outside of the area of service (AoS) of the network slice to have no radio resources or limited radio resources to serve the network slice. The operator may use existing access network (e.g. NG-RAN) configuration by the Operations, Administration and Maintenance (OAM) for this purpose.

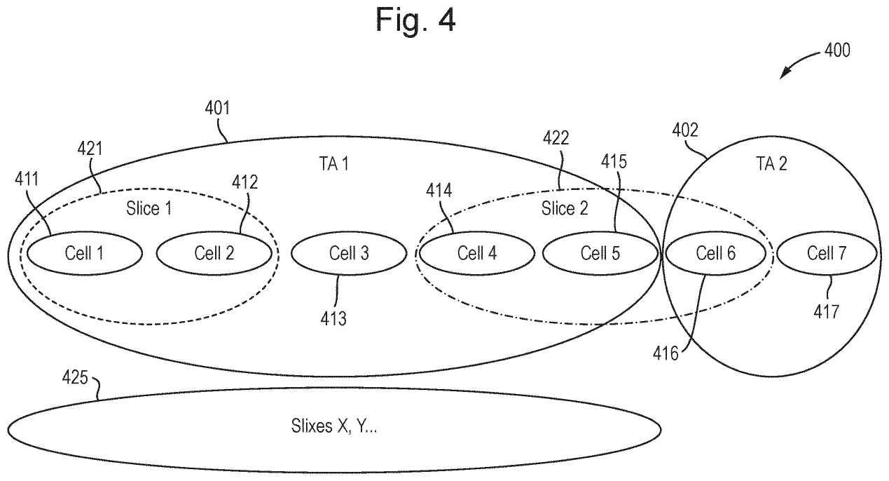

FIG. 4 shows one example of network slice deployment in the radio access network 400. Cells 1 to 7 are shown numbered 411 to 417 respectively. Two tracking areas (TA) are shown—TA 1 401 containing cells 1 to 5 (411 to 415) and TA 2 402 containing cells 6 and 7 (416 and 417). The network slices S-NSSAI #X and S-NSSAI #Y, illustrated as 425 (shown at the bottom of the figure), are deployed to cover all cells that are part of the TA 1. Further, a network slice S-NSSAI #1 (or “slice 1” as shown in the figure and labelled as 421) is served or deployed in cells 1 and 2 (411 and 412) only; and the network slice S-NSSAI #2 (or “slice 2” as shown in the figure and labelled Slice 2 422) is deployed in the coverage of cells 4, 5 and 6 (414, 415 and 416). In this example, the S-NSSAI #2 422 is supported in parts of TA 1 (namely cells 4 and 5 (414 and 415)), and in parts of TA 2 (namely cell 6 (416)).

The network slice AoS may be also configured in the UE by sending signalling which includes the availability information of the network slice. However, only new UEs, e.g. implemented according the Release 18 standard, will support such functionality. Legacy UEs, that is existing UEs developed before the completion of 3GPP Rel-18, may not support the availability information of the network slice.

As such, there exists a problem of how a network (e.g. PCF) will configure a legacy UE (i.e. pre Rel-18) with available means to avoid the UE from initiating network slice registration and PDU Session establishment towards a network slice which is not deployed in a certain area or which is not available for a given time.

During the study phase in 3GPP Rel-18, it is studied how to provide the slice restriction information to the UE and solutions are documented in TR 23.700-41. The following solutions are described. In one solution it is proposed to provide the network slice availability policy to the UE as a new container either from the PCF or from the AMF. There is a solution proposing to provide the slice availability policy to the UE within the Configured NSSAI. In another solution, numbered #21 in TR 23.700-41 and called “Temporary slice based on URSP”, it is suggested that the PCF obtains the information of the temporary slice, (i.e. serving time window of a slice or serving area of a slice) from the UDR. The PCF should generate the Route Selection Validation Criteria in the URSP based on the information of the temporary slice.

Even if such solutions are adopted, it is still not clear how the PCF could be made aware of the network slice time availability conditions if they are specific per UE. Further, it is not clear how the PCF could be made aware of the location availability of a network slice where this is known in the RAN and AMF.

There is presented herein a method that uses the UE Route Selection Policy (URSP), and more specifically the Route Selection Validation Criteria of the Route Selection Descriptor (RSD), in order to configure the availability of a network slice to the UE. To facilitate this solution, there is a need for the UE-PCF know the network slice availability information. There is further presented herein a method to provide the network slice availability information to the PCF responsible for the URSP creation. The network slice availability information is used by the PCF for the creation of RSD validation criteria for a URSP rule. Usually, such a PCF is referred to UE-PCF as it creates the policies to be configured in the UE. Herein, the term PCF will be used for reference to a UE-PCF.

The network slice availability information is associated with a specific network slice, e.g. identified by S-NSSAI, and includes at least one of location and/or time availability information for the network slice.

Location availability information of the network slice is also referred to as Area of Service (AoS) of the network slice. This describes the area where a network slice is supported or deployed. Such a description may take the form of a list of cells, and may be expressed as a list of cell identifiers.

Time availability information of the network slice, may be expressed in a time window (e.g. serving time window described as “start time” and “end time”) or availability at certain days (e.g. available every Saturday and Sunday), and/or periodicity of the availability (e.g. from 10:00 t0 12:00 every day which means periodicity of 24 hours). The “time” may be expressed in daytime (e.g. hour+minutes+seconds) and date. Please note that it is also possible to include “start time” with a certain value and the “end time” with ‘unlimited’ value, which would mean that the network slice is available after the start value but without end value. Vice versa it is possible that only “end time” value is deterministic and no “start time” value is included.

In one possible solution, the PCF can be configured with the network slice availability information by the management system (e.g. OAM system). This is possible if there are only few PCF instances and if the network slice availability information is applicable to any UE subscribed with the network slice. However, in a situation where the network slice availability information is specific to one or more UEs (i.e. a group of UEs) or based on the subscriber type, then a dynamic solution is needed where the PCF is provided with the information depending on the particular UE for which the URSP policies are to be created.

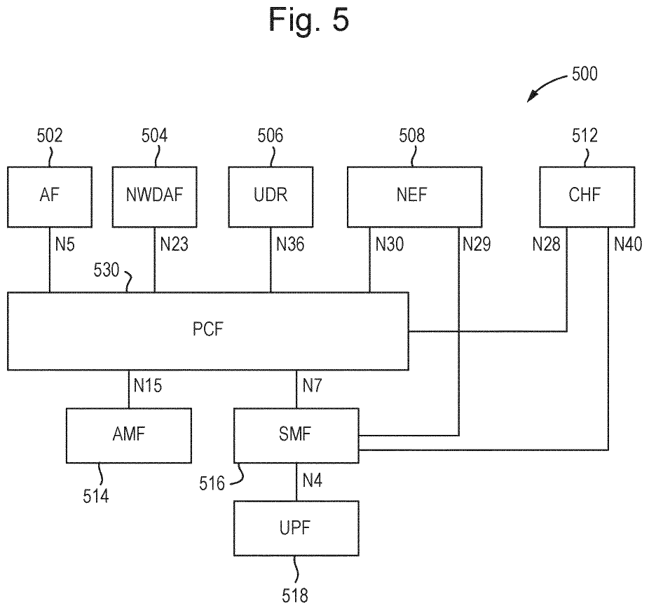

FIG. 5 shows the reference architecture of policy and charging control framework for a 5G System 500. The 5G System 500 comprises an Application Function (AF) 502, a Network Data Analytics Function (NWDAF) 504, a Unified Data Repository (UDR) 506, a Network Exposure Function (NEF) 508, a CHarging Function (CHF) 512, an Access and Mobility management Function (AMF) 514, a Session Management Function (SMF) 516, a User Plane Function (UPF) 518, and a Policy Control Function (PCF) 530. It should be noted that operation of a Policy Control Function (PCF) may be split between two instances. An SM-PCF may provide session management policy control for a UE, and so operates as PCF for the PDU Session. A PCF providing non-session management policy control for the UE is a PCF for the UE, and may be referred to as the UE-PCF. Further details about the PCF architecture can be found in 3GPP TR 23.503, V17.6.0, 2022-09, “Policy and charging control framework for the 5G System (5GS)”, incorporated herein by reference.

According to the solution described herein the AMF receives information related to the availability of a network slice (e.g. from the RAN nodes, UDM or from the OAM system). The AMF receives the UE capability with regard to the support of network slice availability policy/information. Based on the above information, the AMF determines whether to provide the network slice availability information to the PCF (e.g. during the signalling for UE policy association establishment). The PCF receives the network slice availability information (either from AMF or from UDR). The PCF creates URSP rules for the UE and takes the network slice availability information for determining the Route Selection Validation Criteria of the RSD. The PCF may put the URSP rules created based on the network slice availability information is a separate Policy Section Identifier (PSI). The PCF may store in the UDR the PSI(s) created based on the network slice availability information with an additional associated parameter identifying that the policies within this PSI are created by considering the network slice availability information for a specific S-NSSAI.

Please further note that the description uses the term PLMN as public network, but the solution may also apply to non-public networks, e.g. SNPNs.

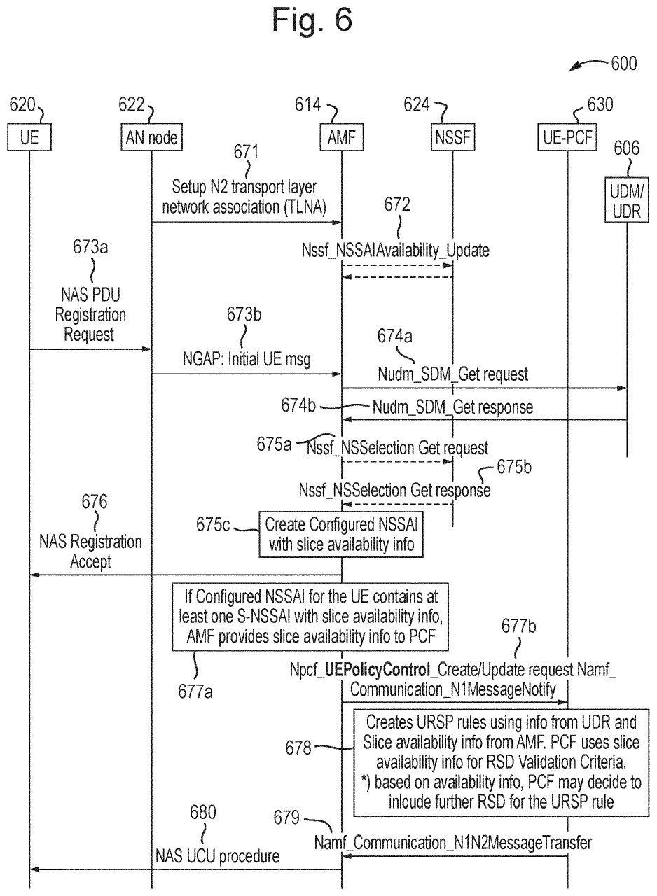

FIG. 6 shows a signalling flow 600 of how an AMF 614 provides slice availability information to the PCF 630. The signaling flow 600 encompasses a UE 620, an Access Network (AN) node 622, an AMF 614, a Network Slice Selection Function (NSSF) 624, a UE-PCF 630 and a UDM/UDR 606. The UE 620 may be embodied as a remote unit 102, a user equipment apparatus 200, and/or a UE 720 as described herein.

The process 600 can be separated into two phases. In phase 1 steps 671 and 672 show how the RAN and AMF are configured about the area of service of the deployed network slices. Each RAN node sends the local configuration information associated with the network slice deployment to the AMF. This is per network slice level signalling. In phase 2 steps 673 to 678 show how the URSP rules are created in the PCF on per UE basis wherein the network slices availability information is considered. This phase uses per-UE signaling during registration procedure or UE Configuration Update (UCU) procedure.

The access network (AN) node 622 is a general denotation of a node/entity from the access network (e.g. radio access network, RAN) which communicates with the core network; and can be eNB, gNB, TNGF, N3IWF, etc.

Upon new instantiation of the AN node 622, or re-configuration of the AN node 622 (e.g. to configure the access network with new or update the existing network slice configuration), the AN node 622 performs setup or update of the N2 transport layer network association (TLNA) with each of the connected AMFs 614. Multiple AN nodes may have the capability to support multiple TNL associations per AMF 614. At 671, the AN node 622 sends among others the supported tracking areas codes (e.g. support TA1 and others) and the list of supported network slices per TA (e.g. S-NSSAI #X and S-NSSAI #Y). In addition, it is proposed that the AN node sends the area of service (AoS) for network slices which are deployed in area not matching to a TA. For example, the AoS for S-NSSAI #1 may contain a list of cell IDs where the S-NSSAI is supported. Additionally, the TAs associated with the cells of the AoS is also included. For example, the AN node can send to the AMF the information that:
the S-NSSAI #1 is supported in cells 1+2 part of TA1; and
the S-NSSAI #2 is supported in cells 4+5 part of TA1 and cell 6 part of TA2.

Note that the AoS of S-NSSAI #1 can be generalized as network slice location availability information, or location availability information for S-NSSAI #1. As shown in FIG. 6, the message at step 671 comprises a setup N2 transport layer network association (TLNA). This may include TA1 supports {[S #X, Y]; AoS S #1 (cells 1+2)}.

In one alternative, the AMF may be configured with the network slice location availability information by the OAM system.

At 672, the AMF 614 updates the NSSF 624 about the network slice location availability information for S-NSSAI #1. For example, the AMF 614 may use the service operation Nssf_NSSAIAvailability_Update and update the NSSF 624 with the network slice location availability information. For example, the AMF 614 sends to the NSSF 624 the information that the S-NSSAI #X and S-NSSAI #Y are supported in TA1; S-NSSAI #1 is supported in cells 1+2 part of TA1; and S-NSSAI #2 is supported in {cells 4, 5 part of TA1 and cell 6 part of TA2}. Such a message may indicate TA1 supports {[S #X, Y]; AoS S #1 (cells 1+2)}.

Based on information about the network slice time availability, e.g. as described in step 674b, the AMF 614 may also send update to the NSSF 624 to include the time availability information for an S-NSSAI.

At 673a, the UE 620 performs registration procedure by sending NAS PDU Registration Request message to the network. The UE 620 includes among others the Requested NSSAI and its capabilities to support of slice availability information/policy. The capabilities to support of slice availability information may be subdivided to capability to support location availability information and capability to support time availability information. The message may indicate Requested NSSAI and capability for slice availability policy.

The capabilities to support of network slice availability information may be included as one or more new parameter(s) in the 5GMM capability sent from the UE 620 to AMF 614. The AMF 614 stores the UE's capabilities to support of slice availability information in the UE 620 context in the AMF 614.

At 673b, the AN node 622 forwards the registration request message to the AMF 614 encapsulated in N2 interface NGAP message. Such a message may include cell ID, TAC, NAS PDU.

At 674a, during the registration procedure, after successful network authentication and authorisation, the AMF 614 retrieves the UE subscription data from the UDM 606. The AMF 614 may use service operation Nudm_SDM_Get request.

At 674b, the UDM 606 sends to the AMF 614 the UE subscription data, which may be enhanced to include network slice availability information for any of the subscribed network slices for the UE 620, for which the network slice availability information applies and for which the UDM or UDR has stored availability or restriction information. In particular, the network slice availability information may contain only time availability information. For example, the message may comprise SUPI, Subscribed S-NSSAIs and for each S-NSSAI a time availability (or time restriction) and/or location availability (or location restriction) information may be provided. In a particular example, the UE Subscription data type “Slice Selection Subscription data” or “Access and Mobility Subscription data (data needed for UE” (i.e. the data types where the Subscribed S-NSSAIs is stored and provided from the UDM to the AMF) can be enhanced to include one or more new fields including the information that for each S-NSSAI in the Subscribed S-NSSAIs, one or more time validity and/or location validity information is associated with the S-NSSAI. In addition, the UDM can provide to the AMF a “Restriction mode when availability conditions are not met” (e.g. see step 6 for SAVI format) associated with the S-NSSAI.

It is beneficial to include the network slice availability information for a subscribed network slice in the UE subscription data, if the network slice time availability is specific for a UE (e.g. for the type of subscription), or if the network slice time availability is to be used when the UE roams to another network is requires to use the network slice in the HPLMN, i.e. so that the visited serving network can know the slice availability in the home network (e.g. in home-routed PDU Session traffic). In roaming case the time availability of the HPLMN S-NSSAI would be applicable, as the location availability of the HPLMN S-NSSAI is applicable in the HPLMN coverage.

If, however, the network slice time availability is applicable only in the current serving network (e.g. for local-breakout LBO PDU Session traffic) and/or if the time availability information for a network slice is common for all subscribers independent of the subscription, then it is beneficial to configure the time availability information in the AMF 614 or NSSF 624 locally (e.g. from the OAM system).

At 675a, if the AMF 614 uses the NSSF 624 services during the registration procedure, e.g. to determine the Allowed NSSAI, Configured NSSAI and/or registration area, the AMF 614 sends Nssf_NSSelection Get request to the NSSF 624. The AMF may include among other input parameters the current UE's TA identity (TAI), the UE's Subscribed S-NSSAIs, the Requested NSSAI, and the network slice availability information for each of the Subscribed S-NSSAIs. For example, the AMF 614 creates the network slice availability information for S-NSSAI #1 based on information received from the AN node 622 in step 671 and/or information received from the UDM 606 in step 674b. In other words, the AMF 614 may process and create a new network slice availability information associated with the S-NSSAI #1 sent to the NSSF 624. Please note that this applies in case that the UE has indicated support of network slice availability information is step 673.

At 675b, the NSSF 624 may return to the AMF 614 in the Nssf_NSSelection Get Response message among others the determined Allowed NSSAI, the registration area (e.g. where the Allowed NSSAI is supported), the Configured NSSAI and further parameters. The Configured NSSAI (or alternatively the Allowed NSSAI) may include network slice availability information for each of the slices where applicable. For example, the if S-NSSAI #1 is part of the Configured NSSAIs and network slice availability information is applicable for S-NSSAI #1, the NSSF may include a new parameter or information element (IE) indicating the network slice availability information which is associated with the Configured NSSAI. An example of the new IE called “NSAVI” is shown in step 677.

At 675c, in case that the AMF 614 does not use the NSSF 624 services, the AMF 614 may perform the functionality described in step 675b in order to determine the Allowed NSSAI, the corresponding registration area, the Configured NSSAI and further NAS configuration parameters. The AMF 614 may create the network slice availability information for any of the S-NSSAIs part of the Configured NSSAI, if the network slice availability information applies, and optionally if the UE 620 has indicated support of the network slice availability information in step 673. The AMF 614 stores in the UE context the network slice availability information associated with an S-NSSAI. The AMF 614 may determine the Allowed NSSAI, the partially/conditionally allowed NSSAI, rejected NSSAI and/or partially/conditionally rejected NSSAI based on the network slice availability information.

If the UE has not indicated support of network slice availability information, the AMF does not provide the network slice availability information to the NSSF, but instead the AMF creates a flag in the UE's context stored in the AMF that for the S-NSSAI, which is associated with network slice availability information, the AMF should enforce network-based policing/enforcement of the network slice availability information. Please note that, e.g. based on configuration in the AMF, the AMF may monitor and enforce the network-based policing even if the UE is capable of the network slice availability information, as the network (e.g. AMF) may not rely on the UE implementation or may want to monitor and enforce actions from the network side. Such enforcement is performed after the registration procedure is completed and for the time duration while the UE is registered with the S-NSSAI. By this, the network (i.e AMF together with SMF) assures that the network resources of the S-NSSAI are used by the UE only within the network slice availability conditions.

In one solution, which can be described as an AMF-based solution, the AMF monitors and trigger actions for S-NSSAI deregistration, PDU Session release procedure or UP deactivation procedure according to the “Restriction mode when availability conditions are not met”. In other words, the AMF monitors whether the UE uses the S-NSSAI resources within the available conditions (time window and location availability), whereas “use of S-NSSAI” may mean either the UE is registered with the S-NSSAI (e.g. the S.NSSAI is part of the allowed NSSAI); or the UE has established PDU Session (i.e. the PDU Session context is established in the UE, AMF, SMF, PCF, etc. but no user plane resources are used); or the UE has established PDU Session and the user plane resources are used. Such “use of S-NSSAI” can correspond to the “Restriction mode when availability conditions are not met” as described in Table 2, however, the Table 2 describes the information sent to the UE, whereas here the “Restriction mode when availability conditions are not met” is used internally in the AMF. For the purpose of monitoring the “use of S-NSSAI” in the AMF, the AMF may (1) compare the current UE location with the location availability information stored for the S-NSSAI and/or (2) the AMF may compare the current time with the time availability information stored for the S-NSSAI. When the AMF determines that the location/time availability conditions are not met, the AMF enforces the following handling depending on the “Restriction mode when availability conditions are not met” and the current use of the S-NSSAI by the UE, for example listed in the following bullets [A] and [B]:

[A] In case that the UE is registered with the S-NSSAI (i.e. the S-NSSAI is part of the allowed NSSAI) and the availability conditions are not met: if the “Restriction mode when availability conditions are not met” indicates that the S-NSSAI is not allowed to be kept registered (i.e. not part of allowed NSSAI), the AMF triggers a procedure to remove the S-NSSAI from the allowed NSSAI, e.g. by using UE configuration update procedure (e.g. NAS UCU procedure). The AMF may include the not-available S-NSSAI either (1) in the rejected NSSAI with a corresponding cause value indicating that the S-NSSAI is rejected due to outside of the availability conditions, or (2) in the conditionally/partially allowed NSSAI; or (3) just exclude the S-NSSAI from the allowed NSSAI (i.e. without including the S-NSSAI in the rejected NSSAI). Further, the AMF initiates towards the SMF(s), which serve the PDU Session(s) associated with the S-NSSAI, a session management procedure (e.g. PDU Session context release or PDU Session context update procedure). Such release of the PDU Session(s) is described in bullet [B.1]. If the “Restriction mode when availability conditions are not met” indicates that the S-NSSAI is allowed to be kept registered (i.e. can remain part of the allowed NSSAI), the AMF does not need to reconfigure the UE to remove the S-NSSAI from the allowed NSSAI, but may perform B below.

[B] In case that the UE is registered with the S-NSSAI and the UE has established PDU Session associated with the S-NSSAI and the availability conditions are not met, it depends on the type of the “Restriction mode when availability conditions are not met”:

[B.1] If the “Restriction mode when availability conditions are not met” indicates that the PDU Session should be released (i.e. the PDU Session context in the UE, AMF, SMF, PCF, etc. should be removed), the AMF may trigger the SMF to initiate the PDU Session release. The AMF may use either Notification procedure (if the SMF has previously subscribed for notifications associated with the S-NSSAI) or SM context update procedure (e.g. Nsmf_PDUSession_UpdateSMContext request message) or SM context release procedure (e.g. Nsmf_PDUSession_ReleaseSMContext request message) to notify the SMF about the need to release the one or more PDU Session(s) associated with the S-NSSAI. The AMF may indicate to the SMF the reason for release, e.g. the S-NSSAI is not available for the UE, whereas the S-NSSAI may not be available due to location restrictions or time restrictions. The AMF may trigger this notification to all SMFs which maintain one or more PDU Sessions associated with the S-NSSAI.

[B.2] If the “Restriction mode when availability conditions are not met” indicates that the PDU Session context in the control plane (e.g. in UE, AMF, SMF, PCF, etc.) can be kept established but the user plane (UP) resource should not be established, the AMF may inform the SMF to keep the PDU Session established, but to disallow the activation of user plane resources as long as the availability conditions are not fulfilled. The AMF may inform the SMF by using the procedures as described in bullet B.1., with the difference that the AMF informs the corresponding SMF(s) that the UP resources should be kept deactivated and optionally the conditions under which the UP resources are kept deactivated, e.g. the location/time conditions.

In another solution, alternative to A, B.1 and B.2, which can be described as combined AMF and SMF based solution, where the AMF monitors and trigger actions for S-NSSAI deregistration and the SMF monitors and triggers action for PDU Session release procedure or UP deactivation procedure according to the “Restriction mode when availability conditions are not met”. The following handling applies:
If the “Restriction mode when availability conditions are not met” indicates that the S-NSSAI has to be deregister, the AMF monitors the availability conditions as described in step 5c above. If the availability conditions are not fulfilled, the AMF triggers the actions to (a) deregister/remove the S-NSSAI from the allowed NSSAI (e.g. the AMF performs the UCU procedure to updated the network slice configuration in the UE by removing the S-NSSAI from the allowed NSSAI) and (b) the AMF triggers release of the existing PDU Sessions to the SMF(s) as described in bullets A, B.1 and B.2 above.
If the “Restriction mode when availability conditions are not met” indicates that the S-NSSAI can be kept registered but either (a) the UP connection of the PDU Session has to be deactivated or (b) the PDU Session has to be released, the AMF sends to the SMF, e.g. during the PDU Session establishment procedure, the information about availability requirements/conditions associated with the PDU Session on the specific S-NSSAI. In this way the PDU Session management, i.e. monitoring and executing actions for the PDU Session is performed by the SMF. The AMF does not monitor the location/time availability conditions. The information sent from the AMF to the SMF can comprise (1) PDU Session availability conditions and (2) corresponding actions to be performed by the SMF. For example, the AMF sends to the SMF information about (1) the location/time availability conditions related to the PDU Session and (2) the action to be taken when the conditions are not met (e.g. either release the PDU Session, or keep the PDU Session context in the control plane but deactivate UP resource). For example, the AMF sends to the SMF such information during the SM context creation procedure (e.g. Nsmf_PDUSession_CreateSMContext request message) or SM context update procedure (e.g. Nsmf_PDUSession_UpdateSMContext request message). Then the SMF monitors the location/time availability conditions when the PDU Session is established. For the location availability condition, the SMF may subscribe with the AMF for location notifications when the UE is inside (or outside) of an area of interest (e.g. AMF sends notification to the SMF when the UE enters and exits a location area or area of interest). The SMF determine whether the location availability condition(s) are met/fulfilled when the UE is inside of the location availability area or area of interest. For the time availability condition, the SMF may compare the current time with the time availability conditions/information stored in the PDU Session context and the SMF may determine whether the condition(s) are met. When the SMF determines that the PDU Session availability conditions are not met, the SMF executes the actions, e.g. according to the information about the corresponding provided by the AMF. For example, the SMF performs either the PDU Session release procedure (towards the UE) or UP resource/connection deactivation procedure (towards the AN node) according to the configured action to be performed.

Whether the AMF applies the AMF based solution (including bullet/method A and bullet/method B) or the combined AMF and SMF based solution can be either (1) configured locally in the AMF for the S-NSSAI (e.g. from the OAM system) or (b) received from the UDM in step 674b. In case (b) the UDM may send information about the actions to be performed when the network slice availability conditions are not fulfilled/met, i.e. information similar to “Restriction mode when availability conditions are not met” which is associated with the S-NSSAI. For the purpose of (b), the UE subscription data stored in the UDM is enhanced to include “Restriction mode when availability conditions are not met” associated with the S-NSSAI, to which availability information/conditions apply. The benefit of using method (b) is that the actions to the performed when the network slice availability conditions are not fulfilled can be configured on per UE basis (i.e. for different UEs different actions may be applied) and the actions are controlled by the home network (e.g. HPLMN) when the UE is roaming to a visited network.

At 676, the AMF 614 sends to the UE Registration accept message to acknowledge the registration procedure and to provide the provide the NAS configuration information to the UE 620. In addition, as the AMF 614 or together with the NSSF may have determined in steps 675b or 675c, the AMF 614 includes the network slice availability information (NSAVI) in the registration accept message. The registration accept message may comprise, among other parameters, a registration area, Allowed NSSAI, Configured NSSAI (S-NSSAI #1, S-NSSAI #X, S-NSSAI #1 availability info) whereas the Configured NSSAI shows that NSAVI is provided for S-NSSAI #1, but not for S-NSSAI #X. Please note that the enhanced Configured NSSAI format (or alternatively Allowed NSSAI format) to include the NSAVI is created and provided to the UE, if the UE has indicated support of NSAVI in step 673.

One example of the NSAVI is shown in the following Table 1.

TABLE 1
NSAVI information element

| | | | | | | | |
|---|---|---|---|---|---|---|---|
| 8 | 7 | 6 | 5 | 4 | 3 | 2 | 1 |

| | |
|---|---|
| NSAVI information IEI | octet 1 |
| Length of NSAVi information contents | octet 2 |
| | octet 3 |
| NSAVI for S-NSSAI 1 | octet 4 |
| | octet m |
| NSAVI for S-NSSAI 2 | octet m + 1* |
| | octet n* |
| . . . | octet n + 1* |
| | octet u* |
| NSAVI for S-NSSAI x | octet u + 1* |
| | octet v* |

The NSAVI informational element (IE) may contain an entry for the network slice availability information for each S-NSSAI which is part of the Configured NSSAI for the network (e.g. for a specific PLMN). The NSAVI IE can be also provided to the UE for the Default Configured NSSAI which applies to any network (e.g. for any PLMN ID).

For each NSAVI for S-NSSAI the format from Table 2 may apply:

TABLE 2
NSAVI values for S-NSSAI

| | |
|---|---|
| Length of NSAVI for S-NSSAI | octet 4 |
| S-NSSAI value | octet 5 |
| | octet v |
| Location availability information | octet v + n |
| (list of one or more cell IDs | |
| associated with corresponding TAI) | |
| Time availability information | octet w* |
| (start time, end time, periodicity) | octet w + m |
| Restriction mode when availability | octet z* |
| conditions are not met. | octet z + x |

The NSAVI information includes the elements as shown in Table 2. The location availability information (e.g. list of cell IDs and associated tracking area code, TAC, or tracking area ID, TAI, of the cells) and the time availability information (e.g. start time, end time, periodicity, etc.) is already described in other parts of this document. The “Restrictions mode when availability conditions are not met” element may at least one of the following modes: (a) allowed to keep the S-NSSAI registration (i.e. S-NSSAI is part of the allowed NSSAI or partially allowed NSSAI) and PDU Session established but the User Plane (UP) resources of the PDU Session are deactivated; (b) allowed to keep the S-NSSAI registration but release all PDU Sessions to this S-NSSIA; or (c) deregister from the S-NSSAI.

Upon reception of the NSAVI IE, the UE 620 may UE request registration to S-NSSAI #1 (to which the received NSAVI applies) when at least one of the following conditions is met: (A) the UE is located in a TA part of the location availability information, (i.e. in TAI associated with the current cell); (B) the UE is located in an area (e.g. cell) which is part of the location availability information; and/or (C) the current time is within the time availability information.

Further, the UE may request the establishment of a PDU Session towards the S-NSSAI #1 (to which the NSAVI applies) only when at least one of the following conditions are met: (A) the UE is located in an area (e.g. cell) which is part of the location availability information; and/or (B) the current time is within the time availability information.

At 677a, the AMF 614 determines to either establish a new UE policy control association or to update an existing one. The AMF 614 determines to provide the network slice availability information to the PCF (e.g. UE-PCF 630) during the UE policy association establishment procedure when one of the following applies:
If the Configured NSSAI for the UE 620 contains at least one S-NSSAI, for which NSAVI applies; or
The UE 620 has indicated during step 673 that the UE 620 does not support capability to handle network slice availability policy. In this case, the AMF 614 determines that network-based mechanism for NSAVI should be enabled. In addition, the AMF 614 may determine to forward the NSAVI to the PCF 630 in order to allow creation of URSP rule which can steer the UE behaviour towards the specific S-NSSAI.

The AMF 614 may keep track in the UE's context that the network slice availability information for S-NSSAI #1 has been sent to the PCF 630 during the UE policy control association establishment. This would allow the AMF 614 to determine whether to send or not send to the PCF 630 the network slice availability information in the next signalling interaction related to this UE 620. For example, if the AMF 614 sends later a new signalling message to the PCF 630 for the same UE 620, e.g. when the UE 620 sends its PSIs, the AMF 614 may apply one of:
The AMF 614 does not include the network slice availability information, if the information hasn't changed since the last time; or
The AMF 614 includes the network slice availability information if an additional indication whether it has changed (or not changed) since the last time.

At 677b, the AMF 614 sends to the PCF 630 a request to establish or to update the UE policy control association. For this purpose, the AMF 614 may send an Npcf_UEPolicyControl_Create or an Npcf_UEPolicyControl_Update request message. Optionally, the AMF 614 may send an Namf_Communication_N1MessageNotify message if the UE policy association has been established already. The AMF 614 sends to the PCF 630 at least one of: the UE's subscription ID (SUPI), the UE provided Policy Section Identifiers as received from the UE 620 (e.g. during step 673) and the network slice availability information associated with an S-NSSAI (in this example: S #1 availability info).

The PCF 630 may send to the AMF 614 an Npcf_UEPolicyControl_Create or an Npcf_UEPolicyControl_Update response message.

At 678, if the PCF 630 doesn't have the policy subscription data for this UE 620 yet, the PCF 630 gets the policy subscription related information and the latest list of PSIs from the UDR 606 using Nudr_DM_Query service operation.

The PCF 630 creates the UE policy container including UE policy information as described section 6.6 of 3GPP TR 23.503, V17.6.0, 2022-09, “Policy and charging control framework for the 5G System (5GS)”, incorporated herein by reference. In addition, the PCF 630 creates URSP rules the Slice availability information from the AMF 614. More specifically, the PCF 630 uses the slice availability information to create associated with S-NSSAI #1 to create the Validation Criteria for the RSD including the S-NSSAI #1.

Based on the availability information, the PCF 630 may decide to include further RSD for the URSP rule.

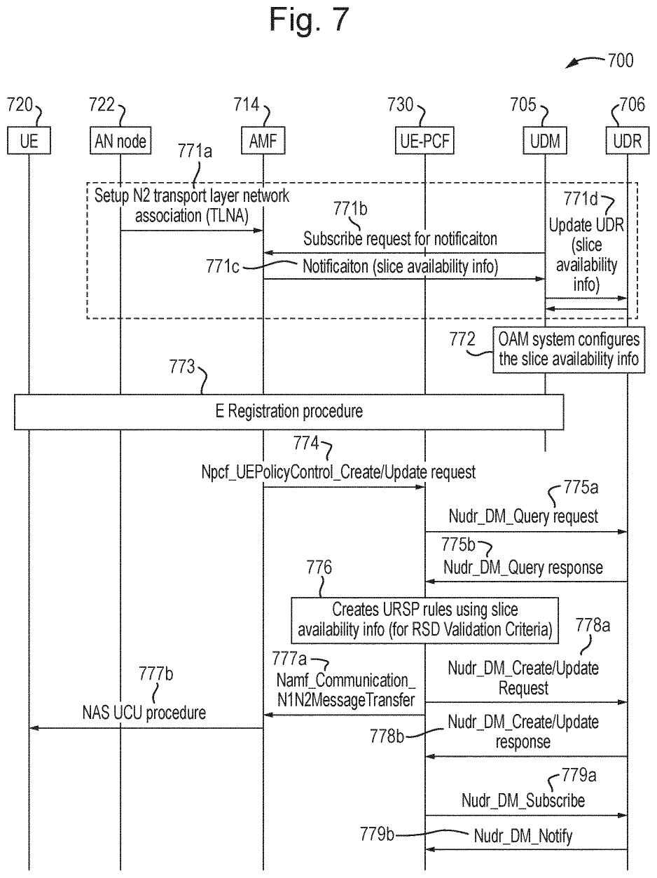

The PCF may in addition perform the following actions (described in further details in FIG. 7 step 778 and 779):
The PCF 630 may put the URSP rules created based on the network slice availability information is a separate Policy Section Identifier (PSI).
The PCF 630 may store in the UDR 606 the PSI(s) created based on the network slice availability information with an additional associated parameter identifying that the policies within this PSI are created by considering the network slice availability information for a specific S-NSSAI.

At 679, the PCF 630 triggers UE Configuration Update Procedure in section 4.2.4.3 of 3GPP TS 23.502, V17.6.0, 2022-09, “Procedures for the 5G System” to provide the UE policy container including UE policy information to the UE 620. The PCF 630 may send Namf_Communication_N1N2MessageTransfer message containing the SUPI, UE policy container. In the case of roaming, the Home-PCF (H-PCF) of the home network provides the UE policy container in the Npcf_UEPolicyControl UpdateNotify Request to the Visited-PCF (V-PCF) of the network roamed to.

At 680, the AMF 614 performs the NAS UE configuration update (UCU) procedure towards the UE. The AMF 614 sends the UE policy container. If the URSP rule includes Validation Criteria for the RSD, then the UE may apply one of the following actions (which is similar to the step 676) about the handling of the network slice availability information in the UE:
If the Validation Criteria for the RSD is not fulfilled and the UE is currently not registered with the S-NSSAI from the RSD (i.e. the S-NSSAI is not part of the Allowed NSSAI), the UE does not request registration with the S-NSSAI. The UE may use alternative valid RSD to establish a PDU Session.
If the Validation Criteria for the RSD is not fulfilled and the UE is currently registered with the S-NSSAI from the RSD (i.e. the S-NSSAI is part of the Allowed NSSAI), the UE does not request establishment of a PDU Session to this S-NSSAI. The UE does not initiate a registration procedure to deregister from the S-NSSAI. The UE may use alternative valid RSD to establish a PDU Session.

If an RSD with Validation Criteria is used to establish a PDU Session, during the lifetime of the PDU Session the UE may re-evaluate the Validation Criteria when (1) the UE location changes (e.g. at handover or idle state mobility) or (2) when initiating a Service Request procedure for transitioning from Idle to Connected state or for activating the user plane resources for the PDU Session. If the Validation Criteria are not fulfilled, the UE may apply one of:
(a) the UE does not request the activation of the user plane resources for the PDU Session;
(b) the UE may initiate the release of the PDU Session; and
(c) the UE may use further RSD form this URPS rule to establish a new PDU Session.

A benefit of the solution 600 in the FIG. 6 is that the AMF 614 can decide whether to send to the PCF 630 the network slice availability information, e.g. by considering whether the UE 620 supports the network slice availability information/policy and/or if the UE 620 is configured to use the S-NSSAI to which the network slice availability information applies. The AMF 614 sends the network slice availability information to the PCF 630, then the PCF 630 will consider it during the creation of the URSP rules for the UE 620. The PCF 630 sends the created URSP rules to the UE 620. By sending URSP rules with RSD validation criteria considering the slice availability information, the UE 620 is thus enabled to have an appropriate configuration to not request PDU Sessions towards the S-NSSAI when the network slice availability is not fulfilled. If the UE 620 uses a valid matching (and prioritized) RSD to request registration to the corresponding S-NSSAI (e.g. by using the URSP rule created by considering the slice availability information), the UE 620 would then also not request registration to the S-NSSAI when the network slice availability is not fulfilled. Accordingly, the operation of the wireless communication network is improved, particularly in the use of network slices with legacy UE's.

FIG. 7 illustrates a signalling flow 700 showing how a UDR provides slice availability information to the PCF. The signaling flow 700 encompasses a UE 720, an Access Network (AN) node 722, an AMF 714, a UE-PCF 730 and a UDM 705 and a UDR 706. The UE 720 may be embodied as a remote unit 102, a user equipment apparatus 200, and/or a UE 620 as described herein. The UDR 706 is enhanced so as to maintain and store the network slice availability information per S-NSSAI. For example, the UDR 706 may store network slice availability information in enhanced network slice related policy control requirements. Such an arrangement is similar to the (Remaining) Maximum Slice Data Rate for UL and DL value which may be stored in the UDR 706.

The signalling flow 700 of how the UDR provides the network slice availability information to the PCF can be separated into two phases. Phase 1 including steps 771 and 772 where the UDR is made aware of the network slice availability information. This information is signalled using per network slice signalling.

Phase 2 including steps 774 to 779 where the PCF 730 is provided with the network slice availability information by the UDR 706. This signalling is performed on per a UE basis with the exception of step 779 which is per S-NSSAI level signalling.

The process 700 begins at 771a to 771d, whereby the slice availability information is provisioned and stored in the UDR 706 from other NFs.

Step 771a is similar to step 671 from FIG. 6, wherein the AN node 722 sends among others the supported tracking areas codes (e.g. support TA1 and others) and the list of supported network slices per TA (e.g. S-NSSAI #X and S-NSSAI #Y). In addition, the AN node 722 may send the area of service (AoS) for network slices which are deployed in area not matching to a TA. For example, the AoS for S-NSSAI #1 may contain a list of cell IDs where the S-NSSAI is supported. Additionally, the TAs associated with the cells of the AoS is also included. This message may include TA1 supports {[S #X, Y]; AoS S #1 (cells 1+2)}.

At step 771b, the AMF 714 provides network slice availability information (e.g. location availability information) to the UDM 705. The UDM 705 may subscribe to the AMF 714 for notifications when network slice availability information is available for any S-NSSAI. Such a subscription request may include Event-slice availability info. In step 771c, once the AMF 714 is aware about network slice availability information associated with an S-NSSAI or the network slice availability information is updated, the AMF 714 sends a motivation message to the UDM 705 including the network slice availability information and the associated S-NSSAI.

At step 771d, the UDM 705 may store the network slice availability information in the UDR 706. If the UDM 705 has received the location availability information from the AMF 714 in step 771c, the UDM 705 may either (A) only provide the location availability information to the UDR 706 (assuming that the UDR 706 may store the time availability information in the UE subscription data); or (B) the UDM 705 may add the time availability information. The UDR 706 may store the network slice availability information in enhanced network slice related policy control requirements.

Step 772 is illustrated as an alternative to steps 771a to 771d. Here, the UDR 706 may be configured/provisioned with the network slice availability information from the OAM system. The OAM system is not illustrated in FIG. 7. The OAM system is aware about the network slice availability information from the network slice template parameters and customer requirements (as per Service Level Agreement between the Mobile Network Operator and the network slice customer). Similarly as the OAM system configures the RAN with the location availability information, the OAM system can configure the UDR 706 with the network slice availability information.

At 773, the UE 720 initiates registration procedure. The network performs the registration procedure. The registration procedure triggers the AMF 714 to initiate UE Policy Association Establishment procedure with the PCF 730.

Step 774, is similar to step 677b from FIG. 6, but without sending the network slice availability information to the PCF 630. The AMF 714 uses Npcf_UEPolicyControl_Create/Update request message to request a UE Policy Association Establishment by including the UE's SUPI and UE's provided PSIs.

At 775a, the PCF 730 queries the UDR 706 to retrieve the UE subscription data and policy data. The PCF 730 may use a Nudr_DM_Query request message including the UE's SUPI, and various data types (e.g. Policy Data, UE context policy control data, Policy Set Entry, etc.)

At 775b, the UDR sends the policy control subscription profile information during the UE Policy Association Establishment procedure using Nudr service for Data Set “Policy Data” and Data Subset “UE context policy control data”. The response message may include SUPI, Policy Data, UE context policy control data, and/or S-NSSAI availability info.

The UDR 706 may send to the PCF Nudr_DM_Query response message including the data requested by the PCF is step 775a, but in addition the network slice availability information associated with the S-NSSAI(s) which are subscribed to by the UE 720.

Step 776, is similar to step 678 from FIG. 6. That is, if the PCF 730 doesn't have the policy subscription data for the UE 720 yet, the PCF 730 gets the policy subscription related information and the latest list of PSIs from the UDR 706 using a Nudr_DM_Query service operation.

Steps 777a and 777b are similar to steps 679 and 680 from FIG. 6. That is, at 777a, the PCF 630 triggers UE Configuration Update Procedure in section 4.2.4.3 of 3GPP TS 23.502, V17.6.0, 2022-09, “Procedures for the 5G System” to provide the UE policy container including UE policy information to the UE 720. The PCF 730 may send Namf_Communication_N1N2MessageTransfer message containing the SUPI, UE policy container. Further, at 777b, the AMF 714 performs the NAS UE configuration update (UCU) procedure towards the UE 720. The AMF 714 sends the UE policy container.

At 778a, the PCF 730 puts the URSP rules that have an RSD created based on the network slice availability information, in a separate Policy Section Identifier (PSI). In addition, the PCF 730 may mark the PSI (e.g. while sending the PSI to the UDR 705) that the policies within the PSI are created by considering the network slice availability information for a specific S-NSSAI. For example, the PSI sent to the UDR 706 can be associated with S-NSSAI #1, or can be association with a NSAVI flag. In such way, it would be easier for the PCF 730 to update the UE 720 with the concerned PSI when the network slice availability information for an S-NSSAI has changed. The PCF 730 may send to the UDR 705 the PSIs by using Nudr_DM_Create/Update request message including among other parameters the following: the Key equal to the UE's SUPI and the Policy Set Entry data where one or more of the PSIs are associated with S-NSSAI ID and/or NSAVI flag.

At 778b, the UDR 705 replies with Nudr_DM_Create/Update response message to acknowledge the reception of the message at step 778a.

At 779a, the PCF 730 subscribes to the UDR 705 to be notified when the network slice availability information associated with a specific S-NSSAI changes. For example, the PCF 730 may use Nudr_DM_Subscribe request message where the data set key is the “S-NSSAI” and the notification event ID is set to “network slice availability information”.

At 779b, when the network slice availability information associated with an S-NSSAI changes (i.e. the info which is stored and maintained in the UDR 705), the UDR 705 may send Notification message to the subscribed one or more PCFs to notify the network slice availability information change. The UDR 705 may in addition send to the PCFs the Policy Set Entry containing the PSI associated with the S-NSSAI and the UE's SUPI. The UDR 705 may use the Nudr_DM_Notify service operation including different data types. For example, in one data type identified by the key “S-NSSAI”, the UDR may include the “network slice availability information”. In another data type identified by the UE's SUPI, the UDR may include the Policy Set Entry containing the PSI associated with the S-NSSAI. The UDR 705 may send multiple Policy Set Entries, each associated with a different UE 720.

Upon reception of such notification, the PCF 730 may create a new URSP rule including the updated network slice availability information for the or each UE 720, for which the PCF 730 has established a UE policy association. Afterwards the PCF 730 may trigger the provisioning of the updated UE policy (i.e. updated PSIs) as described in steps 777a and 777b above.

A benefit of the process 700 illustrated in FIG. 7 is that the network slice availability information, which is to be used for the URSP rule creation, is stored and maintained in a single NF, namely in the UDR 706. If the OAM system can locally configure the UDR 706 with the network slice availability information, then the impacts to the 5GC are reduced to the UE-PCF 730 and UDR 706.

It should be noted that in a further alternative, the PCF may be provisioned from different NFs with the network slice availability information. This can be considered as a middle ground or merging of the processes show in FIGS. 6 and 7. In such an example, the AMF sends to the PCF the location availability information (as per steps 677a and 677b in FIG. 6), whereas the UDR sends the time availability information to the PCF (as per step 775b in FIG. 7).

There is provided herein a Policy Control Function (PCF) for a wireless communication network, the PCF comprising a processor and a memory coupled with the processor. The processor is configured to cause the PCF to: receive availability information for a network slice associated with a user equipment (UE); determine at least one UE Route Selection Policy (URSP) rule for the UE, the at least one URSP rule considering the availability information of the network slice; and transmit the at least one URSP rule to the UE. The PCF may be a component of the wireless communication network.

Such an arrangement allows a wireless communication network to configure network slice Area of Service in a legacy UE; where a legacy UE is one that was developed before the completion of 3GPP Rel-18, and which does not support the availability information of the network slice defined therein.

The URSP rule may contain an element that is derived from the received availability information for a network slice associated with a UE. The element may comprise validation criteria. The URSP rule may be created by considering the received availability information for the network slice, but the slice availability information may not be included 1-to-1. For example, the PCF may consider further locally configured policies from the network operator together with the received slice availability information for the network slice. The slice availability information may be used for determining Route Selection Descriptor (RSD) validation criteria for the URSP rule. Accordingly, the at least one URSP rule may include an indication of the availability information of the network slice. The indication of the availability information of the network slice may be derived from the received availability information for a network slice.

The URSP rule may contain a Route Selection Descriptor (RSD) including the network slice and the method further comprises determining RSD validation criteria based on the availability information for the network slice. The URSP rule may contain a further RSD for a different network slice, wherein the different network slice is not restricted by availability information.

The availability information for a network slice may be received from an Access and Mobility Management Function (AMF). The availability information for a network slice may be received from the AMF as part of a UE policy association establishment.

The availability information for a network slice may be received from a Unified Data Repository (UDR). The availability information for a network slice may be received from the UDR as a result of a query for UE subscription data and policy data.

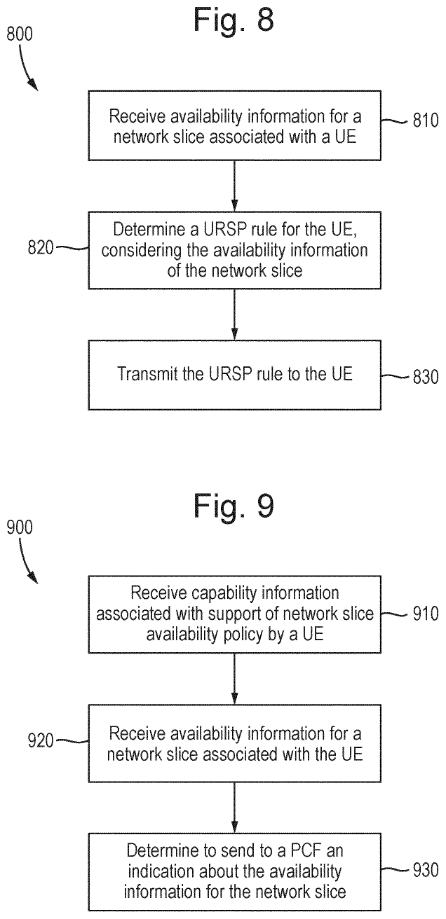

FIG. 8 illustrates a method 800 for a Policy Control Function (PCF), the method 800 comprising: receiving 810 availability information for a network slice associated with a user equipment (UE); determining 820 at least one UE Route Selection Policy (URSP) rule for the UE, the at least one URSP rule considering the availability information of the network slice; and transmitting 830 the at least one URSP rule to the UE.

In certain embodiments, the method 800 may be performed by a processor executing program code, for example, a microcontroller, a microprocessor, a CPU, a GPU, an auxiliary processing unit, a FPGA, or the like.

Such an arrangement allows a wireless communication network to configure network slice Area of Service in a legacy UE; where a legacy UE is one that was developed before the completion of 3GPP Rel-18, and which does not support the availability information of the network slice defined therein.

The URSP rule may contain an element that is derived from the received availability information for a network slice associated with a UE. The element may comprise validation criteria. The URSP rule may be created by considering the received slice availability information, but the availability information for the network slice may not be included 1-to-1. For example, the PCF may consider further locally configured policies from the network operator together with the received slice availability information for the network slice. The slice availability information may be used for determining Route Selection Descriptor (RSD) validation criteria for the URSP rule. Accordingly, the at least one URSP rule may include an indication of the availability information of the network slice. The indication of the availability information of the network slice may be derived from the received availability information for a network slice.

The URSP rule may contain a Route Selection Descriptor (RSD) including the network slice and the method further comprises determining RSD validation criteria based on the availability information for the network slice. The URSP rule may contain a further RSD for a different network slice, wherein the different network slice is not restricted by availability information.

The availability information for a network slice may be received from an Access and Mobility Management Function (AMF). The availability information for a network slice may be received from the AMF as part of a UE policy association establishment.

The availability information for a network slice may be received from a Unified Data Repository (UDR). The availability information for a network slice may be received from the UDR as a result of a query for UE subscription data and policy data.

There is further provided an Access and Mobility Management Function (AMF) for a wireless communication network, the AMF comprising a processor and a memory coupled with the processor. The processor is configured to cause the AMF to: receive, for a User Equipment (UE), capability information associated with support of network slice availability policy by the UE; receive availability information for a network slice associated with the UE; and determine, based on the received capability information and the availability information, to send to a Policy Control Function (PCF) an indication about the availability information for the network slice. The AMF may be a component of the wireless communication network.

The AMF may be further arranged to send the availability information for the network slice associated with the UE to the PCF. The AMF may be further arranged to send the availability information for the network slice associated with the UE to the PCF as part of a UE policy association establishment. The AMF may be further arranged to store, in a UE context, an indication that the availability information for a network slice associated with the UE has been sent to the PCF.

FIG. 9 illustrates a method 900 for an Access and Mobility Management Function (AMF), the method 900 comprising: receiving 910, for a User Equipment (UE), capability information associated with support of network slice availability policy by the UE; receiving 920 availability information for a network slice associated with the UE; and determining 930, based on the received capability information and the availability information, to send to a Policy Control Function (PCF) an indication about the availability information for the network slice.

In certain embodiments, the method 900 may be performed by a processor executing program code, for example, a microcontroller, a microprocessor, a CPU, a GPU, an auxiliary processing unit, a FPGA, or the like.

The method may further comprise sending the availability information for the network slice associated with the UE to the PCF. The method may further comprise sending the availability information for the network slice associated with the UE to the PCF as part of a UE policy association establishment. The method may further comprise storing, in a UE context, an indication that the availability information for a network slice associated with the UE has been sent to the PCF.

There is further provided a Unified Data Repository (UDR) for a wireless communication network, the UDR comprising a processor; and a memory coupled with the processor. The processor is configured to cause the UDR to: receive network slice availability information for a network slice associated with a UE; receive from a Policy Control Function (PCF) a query to retrieve subscription data and policy data for the UE; and send to the PCF the requested subscription data and policy data for the UE and an indication about the availability information for the network slice for the UE. The UDR may be a component of the wireless communication network.

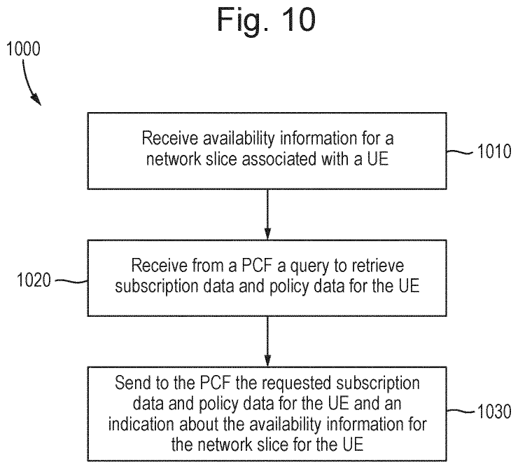

FIG. 10 illustrates a method 1000 for a Unified Data Repository (UDR), the method 1000 comprising: receiving 1010 network slice availability information for a network slice associated with a UE; receiving 1020 from a Policy Control Function (PCF) a query to retrieve subscription data and policy data for the UE; and sending 1030 to the PCF the requested subscription data and policy data for the UE and an indication about the availability information for the network slice for the UE.

In certain embodiments, the method 1000 may be performed by a processor executing program code, for example, a microcontroller, a microprocessor, a CPU, a GPU, an auxiliary processing unit, a FPGA, or the like.

As explained above in connection with step 675c, some variants in the operation of the AMF may be implemented. These variants may be summarized as follows.

There is provided an Access and Mobility Management Function (AMF) for a wireless communication network, the AMF comprising: a processor; and a memory coupled with the processor. The processor is configured to cause the AMF to: receive availability information for a network slice; and receive UE capabilities indicating that a UE does not support network slice availability information. The processor is further configured to cause the AMF to determine, based on receipt of UE capabilities indicating that the UE does not support network slice availability information, to monitor network slice availability conditions and to enforce actions if the availability conditions are not met, and transmit to an SMF information about the session management of a PDU Session for the UE.

The availability information for a network slice may be received from AN node, UDM or locally from OAM system. The UE capabilities may be received from the UE during a registration procedure.

The processor may be further configured to cause the AMF to receive a Restriction mode when network slice availability conditions are not fulfilled, wherein the Restriction mode when network slice availability conditions indicate at least one of: —deregister the UE from the S-NSSAI; —keep the S-NSSAI registration and PDU Session context established but deactivate the user plane resources; —and keep the S-NSSAI registration but release the PDU Sessions associated with the S-NSSAI. The Restriction mode may be received from the UDM.

Determining to monitor network slice availability conditions and to enforce actions if the availability conditions are not met may comprise monitoring the availability conditions and triggering at least one of the following procedures when the availability conditions are not fulfilled and based on a stored indication of a Restriction mode when network slice availability conditions are not fulfilled: —network slice deregistration procedure towards the UE and releasing the corresponding PDU Session towards the SMFs; —releasing the PDU Session wherein the information about the session management of a PDU Session for the UE transmitted to the SMF includes an indication of a PDU Session release request; —or deactivating the UP connection of the PDU Session wherein the information about the session management of a PDU Session for the UE transmitted to the SMF includes an indication of a UP deactivation procedure for the PDU Session.

Note that in this case the AMF does not send the PDU Session availability conditions and associated actions to the SMF.

Determining to monitor network slice availability conditions and to enforce actions if the availability conditions are not met may comprise: —the AMF monitoring and enforcing the actions for the network slice registration status in case of the Restriction mode when network slice availability conditions are not fulfilled indicates deregister the UE from the S-NSSAI, —and the AMF informing the SMF to monitor the PDU Session availability conditions and to enforce the corresponding actions associated with PDU Session.

Informing the SMF to monitor the PDU Session availability conditions and to enforce the corresponding actions associated with the network slice may comprise transmitting to the SMF the information about the session management of a PDU Session for the UE.

The AMF may send to the SMF the information about the session management of the PDU Session, the information about the session management of the PDU Session comprising: the PDU Session availability conditions; and information about the action to be performed by the SMF when the availability conditions are not fulfilled. The action may include one of: the PDU Session context is kept and the UP resources are deactivated, or the PDU Session context is released.

The PDU Session availability conditions may be transmitted during the SM creation procedure or SM update procedure towards the SMF.

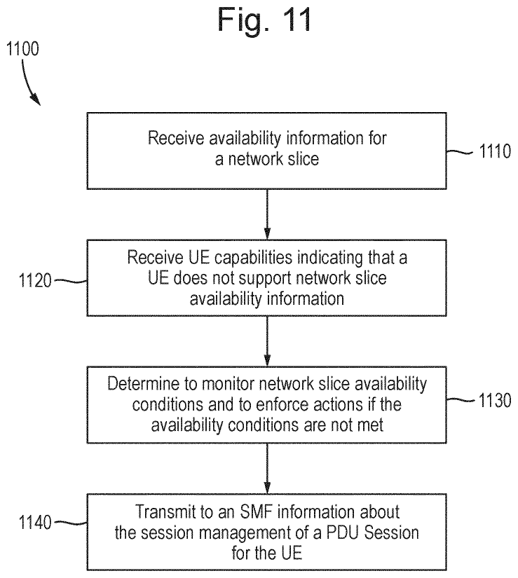

FIG. 11 illustrates a method 1100 performed by an AMF, the method 1100 comprising: receiving availability information for a network slice; receiving UE capabilities indicating that a UE does not support network slice availability information; determining, based on receipt of UE capabilities indicating that the UE does not support network slice availability information, to monitor network slice availability conditions and to enforce actions if the availability conditions are not met; and transmitting to an SMF information about the session management of a PDU Session for the UE.

In certain embodiments, the method 1100 may be performed by a processor executing program code, for example, a microcontroller, a microprocessor, a CPU, a GPU, an auxiliary processing unit, a FPGA, or the like.

The availability information for a network slice may be received from AN node, UDM or locally from OAM system. The UE capabilities may be received from the UE during a registration procedure.

The method may further comprise receiving a Restriction mode when network slice availability conditions are not fulfilled, wherein the Restriction mode when network slice availability conditions indicate at least one of: —deregister the UE from the S-NSSAI; —keep the S-NSSAI registration and PDU Session context established but deactivate the user plane resources; —and keep the S-NSSAI registration but release the PDU Sessions associated with the S-NSSAI. The Restriction mode may be received from the UDM.

Determining to monitor network slice availability conditions and to enforce actions if the availability conditions are not met may comprise monitoring the availability conditions and triggering at least one of the following procedures when the availability conditions are not fulfilled and based on a stored indication of a Restriction mode when network slice availability conditions are not fulfilled: —network slice deregistration procedure towards the UE and releasing the corresponding PDU Session towards the SMFs; —releasing the PDU Session wherein the information about the session management of a PDU Session for the UE transmitted to the SMF includes an indication of a PDU Session release request; —or deactivating the UP connection of the PDU Session wherein the information about the session management of a PDU Session for the UE transmitted to the SMF includes an indication of a UP deactivation procedure for the PDU Session.

Note that in this case the AMF does not send the PDU Session availability conditions and associated actions to the SMF.

Determining to monitor network slice availability conditions and to enforce actions if the availability conditions are not met may comprise: —the AMF monitors and enforces the actions for the network slice registration status in case of the Restriction mode when network slice availability conditions are not fulfilled indicates deregister the UE from the S-NSSAI; —and the AMF informs the SMF to monitor the PDU Session availability conditions and to enforce the corresponding actions associated with PDU Session.

Informing the SMF to monitor the PDU Session availability conditions and to enforce the corresponding actions associated with the network slice may comprise transmitting to the SMF the information about the session management of a PDU Session for the UE.

The AMF may send to the SMF the information about the session management of the PDU Session, the information about the session management of the PDU Session comprising: —the PDU Session availability conditions; —and information about the action to be performed by the SMF when the availability conditions are not fulfilled. The action may include one of: the PDU Session context is kept and the UP resources are deactivated, or the PDU Session context is released.

The PDU Session availability conditions may be transmitted during the SM creation procedure or SM update procedure towards the SMF.

The variant operation in the AMF may result in the following operation of an SMF.

A Session Management Function (SMF) for a wireless communication network, the SMF comprising: a processor; and a memory coupled with the processor. The processor is configured to cause the SMF to: receive, from an AMF, information about a session management of a PDU Session associated with a network slice, wherein the information comprises at least one of: availability conditions for the PDU Session, and actions to be performed by the SMF when the availability conditions are not fulfilled; and initiate a procedure upon determining that the PDU Session availability conditions are not fulfilled.

The availability conditions for the PDU Session may comprise at least one of a location availability condition and a time availability condition. The processor may be further arranged to cause the SMF to: subscribe with the AMF for notification for the UE presence in an area of interest and receiving notifications from the AMF when the UE is within the area of interest. The area of interest may comprise an area corresponding to the location availability condition.

The actions to be performed by the SMF when the availability conditions are not fulfilled may comprise at least one of: the PDU Session context is kept and the user plane resources are deactivated; and/or the PDU Session context is released.

Initiating a procedure upon determining that the PDU Session availability conditions are not fulfilled may comprise initiating at least one of: a core network initiated selective deactivation of the user plane connection of the PDU Session when the action indicates that the PDU Session context is to be kept and the user plane resources are to be deactivated; and a PDU Session release procedure when the action indicates that the PDU Session context is to be released.

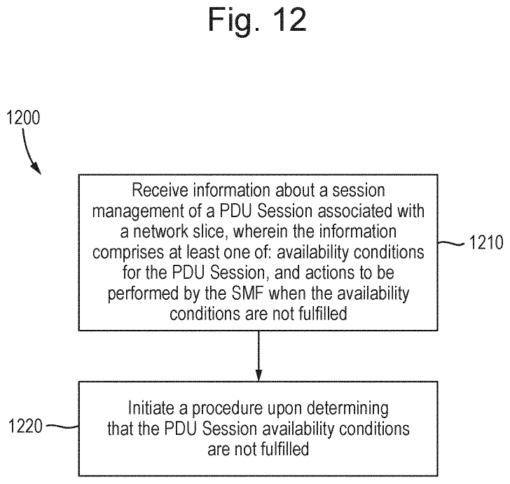

FIG. 12 illustrates a method 1200 performed by an SMF, the method 1200 comprising: receiving, from an AMF, information about a session management of a PDU Session associated with a network slice, wherein the information comprises at least one of: availability conditions for the PDU Session, and actions to be performed by the SMF when the availability conditions are not fulfilled; and initiating a procedure upon determining that the PDU Session availability conditions are not fulfilled.

In certain embodiments, the method 1200 may be performed by a processor executing program code, for example, a microcontroller, a microprocessor, a CPU, a GPU, an auxiliary processing unit, a FPGA, or the like.

The availability conditions for the PDU Session may comprise at least one of a location availability condition and a time availability condition.

The method may further comprise subscribing with the AMF for notification for the UE presence in an area of interest and receiving notifications from the AMF when the UE is within the area of interest. The area of interest may comprise an area corresponding to the location availability condition.

The actions to be performed by the SMF when the availability conditions are not fulfilled may comprise at least one of: the PDU Session context is kept and the user plane resources are deactivated; and/or the PDU Session context is released.

Initiating a procedure upon determining that the PDU Session availability conditions are not fulfilled may comprise initiating at least one of: a core network initiated selective deactivation of the user plane connection of the PDU Session when the action indicates that the PDU Session context is to be kept and the user plane resources are to be deactivated; and a PDU Session release procedure when the action indicates that the PDU Session context is to be released.

Accordingly, there is provided a PCF arranged to: receive an indication for the network slice availability information (either from AMF or from UDM); determine URSP rules including RSD validation criteria created by considering the network slice availability information; transmitting UE's PSIs to the UDR, wherein the PSI may be associated with S-NSSAI and network slice availability information, in case the RSD validation criteria are based on the network slice availability information.

Further, there is provided an AMF arranged to: receive (a) UE capability associated with support of network slice availability policy, and (b) network slice availability from the RAN; determine, based on the received information, to send to the PCF an indication about the availability information for the network slice; and store in the UE context an indication that the network slice availability information has been sent to the PCF during the UE policy association establishment.

The AMF may be further arranged to receive (e.g. from the UDM) a Restriction mode when network slice availability conditions are not fulfilled; and determine whether the AMF monitors the network slice availability conditions and enforces both the S-NSSAI registration status actions (e.g. deregistering the S-NSSAI for the UE) and PDU Session related actions (e.g. sending to the SMF indication that the PDU Session is to be released or the UP connection/resources are to be deactivated). The AMF may be further arranged to determine whether the AMF monitors the network slice availability conditions and enforces the S-NSSAI registration status actions (e.g. deregistering the S-NSSAI for the UE), but informing the SMF to monitor and enforce actions related to the PDU Session, that is, the AMF may be further arranged to send to the SMF (e.g. during SM context creation/update procedure) information about: the PDU Session availability conditions and the corresponding actions to be performed (e.g. whether the PDU Session is to be released or the User Plane connection/resources are to be deactivated).

There is further provided a method for a PCF, the method comprising: receiving an indication about the availability information for a network slice (e.g. from AMF as part of the UE policy association establishment) associated with a UE; determining URSP rules for the UE; and transmitting to the UE the created URSP rules

The URSP rule may contain an RSD with the network slice. The method may further comprise determining RSD validation criteria based on the availability information for the network slice.

The method may further comprise determining to include a further RSD in the URSP rule with a different network slice which is not restricted by availability information.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 5GS/5GC, 5 Generation System/5 Generation Core network; AMF, Access and Mobility Management Function; AS, Access Stratum; BS, Base Station; DSCP, Differentiated Services Code Point; eNB, Evolved Node-B; EPC/EPS, Evolved packet core/Evolved packet system; FQDN, Fully-Qualified Domain Name; gNB, 5G Node-B; ID, Identity; IE, Information Element; LTE, Long Term Evolution; NAS, Non Access Stratum; MM, Mobility Management; MO, Mobile Originated; MPS, Multimedia Priority Service; MT, Mobile Terminated; N3IWF, Non-3GPP InterWorking Function; NAS, Non-Access Stratum; NEF, Network Exposure Function; NPN, Non-Public Network; NR, New Radio; NRF, Network Repository Function; NSSAA, Network slice secondary authentication and authorization; NSSF, Network Slice Selection Function; PCF, Policy Control Function; PDCP, Packet Data Convergence Protocol; PDU, Protocol Data Unit; PLMN, Public Land Mobile Network; RA, Registration Area; RAN, Radio Access Network; RAT, Radio Access Technology/Type; SM, Session Management; SMF, Session Management Function; SMS, Short Message Service; SNPN, Stand-alone Non-Public Network; SUCI, Subscription Concealed Identifier; SUPI, Subscription Permanent Identifier; TA, Tracking Area; TNGF, Trusted Non-3GPP Gateway Function; UDM, Unified Data Management; UDR, Unified Data Repository; UCU, UE configuration update; UE, User Equipment; UICC, universal integrated circuit card; UMTS, Universal Mobile Telecommunication System; URL, Uniform Resource Locator; URSP, UE Route Selection Policy; USIM, Universal subscriber identity module; and (E)-UTRAN, (Evolved) Universal Terrestrial Radio Access Network.

What is claimed is:

1. A Policy Control Function (PCF) for a wireless communication network, the PCF comprising:
at least one memory; and
at least one processor coupled with the at least one memory and operable to cause the PCF to:
receive availability information for a network slice associated with a user equipment (UE);
determine at least one UE Route Selection Policy (URSP) rule for the UE, the at least one URSP rule considering the availability information of for the network slice; and
transmit the at least one URSP rule to the UE.

2. The PCF of claim 1, wherein the at least one URSP rule comprises a Route Selection Descriptor (RSD) including the network slice, and wherein the at least one processor is operable to cause the PCF to:
determine RSD validation criteria based at least in part on the availability information for the network slice.

3. The PCF of claim 2, wherein the at least one URSP rule comprises a further RSD for a different network slice, wherein the different network slice is not restricted by availability information.

4. The PCF of claim 1, wherein the availability information for the network slice is received from an Access and Mobility Management Function (AMF).

5. The PCF of claim 4, wherein the availability information for the network slice is received from the AMF as part of a UE policy association establishment.

6. The PCF of claim 1, wherein the availability information for the network slice is received from a Unified Data Repository (UDR).

7. The PCF of claim 6, wherein the availability information for the network slice is received from the UDR as a result of a query for UE subscription data and policy data.

8. A method performed by a Policy Control Function (PCF), the method comprising:
receiving availability information for a network slice associated with a user equipment (UE);
determining at least one UE Route Selection Policy (URSP) rule for the UE, the at least one URSP rule considering the availability information for the network slice; and
transmitting the at least one URSP rule to the UE.

9. The method of claim 8, wherein the at least one URSP rule comprises a Route Selection Descriptor (RSD) including the network slice, and the method further comprises determining RSD validation criteria based at least in part on the availability information for the network slice.

10. The method of claim 9, wherein the at least one URSP rule comprises a further RSD for a different network slice, wherein the different network slice is not restricted by availability information.

11. The method of claim 8, wherein the availability information for the network slice is received from an Access and Mobility Management Function (AMF).

12. The method of claim 11, wherein the availability information for the network slice is received from the AMF as part of a UE policy association establishment.

13. The method of claim 8, wherein the availability information for the network slice is received from a Unified Data Repository (UDR).

14. The method of claim 13, wherein the availability information for the network slice is received from the UDR as a result of a query for UE subscription data and policy data.

15. An Access and Mobility Management Function (AMF) for a wireless communication network, the AMF comprising:
at least one memory; and
at least one processor coupled with the at least one memory and operable to cause the AMF to:
receive, for a User Equipment (UE), capability information associated with support of network slice availability policy by the UE;
receive availability information for a network slice associated with the UE; and
determine, based at least in part on the received capability information and the availability information, to send to a Policy Control Function (PCF) an indication about the availability information for the network slice.

16. The AMF of claim 15, wherein the at least one processor is operable to cause the AMF to:
send the availability information for the network slice associated with the UE to the PCF.

17. The AMF of claim 15, wherein the at least one processor is operable to cause the AMF to:
send the availability information for the network slice associated with the UE to the PCF as part of a UE policy association establishment.

18. The AMF of claim 15, wherein the at least one processor is operable to cause the AMF to:
store, in a UE context, an indication that the availability information for the network slice associated with the UE has been sent to the PCF.

19. A method fer-performed by an Access and Mobility Management Function (AMF), the method comprising:
receiving, for a User Equipment (UE), capability information associated with support of network slice availability policy by the UE;
receiving availability information for a network slice associated with the UE; and
determining, based at least in part on the received capability information and the availability information, to send to a Policy Control Function (PCF) an indication about the availability information for the network slice.

20. The method of claim 19, further comprising sending the availability information for the network slice associated with the UE to the PCF.

21. (canceled)

22. (canceled)
